(19) United States
(12) Patent Application Publication
(10) Pub. No.: US 2013/0168331 A1
(43) Pub. Date: Jul. 4, 2013

(54) Means for Cleaning Packed Media In a Wastewater Filter Treatment System

(71) Applicant: Robert A. Beggs, Woodland, CA (US)

(72) Inventor: Robert A. Beggs, Woodland, CA (US)

(21) Appl. No.: 13/706,635

(22) Filed: Dec. 6, 2012

Related U.S. Application Data
(60) Provisional application No. 61/567,256, filed on Dec. 6, 2011.

(51) Int. Cl. B01D 24/46

(52) U.S. Cl. 210/793; 210/248; 210/136; 210/151

(57) ABSTRACT

A highly efficient means for progressively backwashing and fluidizing filter media in packed media filtration systems utilized for removing contaminants from wastewater is disclosed. The means is suited for use with a generally unsaturated filter with air and water flowing concurrently in a downward direction during treatment. During periodic backwashing, a pump provides treated wastewater from a holding tank to an underdrain and a pressurized water jet configured as an eductor within the filter vessel to progressively fluidize, backwash and redistribute the media. Fluidized media flow induced by the water jet is turbulently transported to the top of the filter vessel in an upflow pipe, wherein excess biofilm is scoured from the media. Scoured biofilm leaves the filter with backwash water through an overflow conduit and an exit port. Backwashing removes excess solids caught in the filter media and controls the biofilm thickness and the nature of the biofilm.

### RELATED APPLICATIONS

This application is related to previously filed U.S. provisional patent application Ser. Nos. 61/567,256, filed Dec. 6, 2011, and entitled “ ” Means for Progressive Fluidization and Backwash of Unsaturated Filter”. This patent application is incorporated herein by reference as if set out in full.

### BACKGROUND OF THE DISCLOSURE

1. Technical Field of the Disclosure

The present invention relates in general to wastewater treatment systems, and in particular to a highly efficient means for cleaning and redistributing media in packed media treatment filtration systems utilized for removing contaminants from wastewater and other dirty water sources.

2. Description of the Related Art

Wastewater treatment systems often employ one or more aerobic or non-aerobic filters. These filters may be saturated or unsaturated, and may or may not incorporate a backwash function. The trickling filter is one of several conventional filters currently used for wastewater treatment. Trickling filters trickle wastewater through coarse media such as rocks or shaped plastic media. Biological life on the surface of the media provides the primary means for wastewater treatment. These filters are generally not backwashed, and excess growth of biological slime sloughs off the fixed media periodically and is carried out of the filter along with the treated effluent. To remove the slime from the treated effluent, settling clarifiers are often placed downstream from conventional trickling filters to capture and retain the sloughed biological slime. An external clarifier adds significant cost and complexity to the system. Intermittent sand filters and recirculating sand filters are types of trickling filters that utilize a fixed packed media bed, usually composed of sand or gravel. They must be loaded at very low rates to prevent plugging, and are not backwashed.

Another type of filter commonly used in wastewater treatment and in final wastewater polishing is the rapid sand filter. These filters are backwashed by fluidizing the media bed. However, as opposed to trickling filters, these filters are run at a high rate and are fully saturated by maintaining a water head or pressure over the filter surface. As such, rapid sand filters are typically designed and operated to provide only physical filtration. During the backwash phase, the complete media bed is fluidized.

Fluidized nitrifying and denitrifying filters are used in the aquarium and wastewater treatment industries. These filters are often continuously fluidized and are saturated, essentially operating in a continuous washing state.

Continuous backwashing upflow filters utilize an air-lift central pipe to continuously circulate a small flow of water and fluidized media from the bottom of the filter to a cleaning mechanism at the top of the filter. The media is scoured in the cleaning mechanism, and dirty reject water is allowed to flow over a weir. From the cleaning mechanism, the media falls on the top of the filter bed and slowly migrates back downward. Dirty influent water is introduced near the bottom of the filter and flows upward, counter-current to the media movement. Continuous backwashing upflow filters are used in a fully saturated condition. In some applications they are used to provide biological denitrification through microbial growth on the media surfaces in the saturated, anoxic conditions, which exist in the filter.

Conventional filters for aerobic wastewater treatment in unsaturated media typically involve fixed (non-backwashing) media. For the purpose of this application, the term “unsaturated” is defined in the same manner as commonly used in soil science, i.e. having air in some of the pores between media particles and the water on the media particle surfaces having a predominantly negative matric potential. Conventional backwashing media filters involve saturated media with ponded water essentially continuously maintained above the media surface. Generally these saturated filters provide no biological water treatment. Conventional upflow filters that progressively fluidize and scour media also operate in a saturated condition.

Recent advancements in the art provide an unsaturated wastewater filter utilizing packed media intermittently cleaned by media fluidization and backwashing means. See U.S. Pat. No. 7,914,678 (Beggs). The Beggs filter removes pollutants and pathogens from wastewater and other dirty water sources. The filter comprises a periodic backwashing means to lessen the chance that biofilm growth will clog the media pores. However, such backwashing still leaves sufficient biofilm attached to the media to maintain a high level of treatment. The filter utilizes high frequency dosing to cause pore saturation at or near the surface during dosing and shortly thereafter in order to maximize distribution uniformity and to induce downward airflow into the media. However, the filter does not provide a channel for containing vertically circulating media during backwashing and fluidization.

One of the existing wastewater treatment systems describes a pulse-fed unsaturated media filter that provides intermittent forced air above the media prior to each wastewater dose. The airflow induced into the media provides oxygen for nitrification. Interruptions in the supply of air allow anoxic conditions to develop, providing denitrifying conditions. The system provides a method for treating wastewater by providing a first dose of air to aerate a medium bed, supplying a dose of wastewater to the aerated medium bed, allowing nitrification of the wastewater to occur, followed by denitrification, and providing a subsequent dose of air to the medium bed. The system provides a combined aerobic and anaerobic treatment apparatus comprising the medium bed, a wastewater conduit in fluid communication with the medium bed, and an air conduit in fluid communication with the medium bed. However, the system is limited in that it is very large, and can handle only relative low loading rates. In addition, there is no means for backwashing the medium bed.

Another existing wastewater treatment system discloses a continuous filter for suspensions or emulsions flowing upwards through a zone of filter media while the filter media concurrently flows in an opposite downward direction through the filter bed zone. Dirty filter media at the bottom of the filter bed zone is transported through a pipe to a wash device located above the filter bed zone and is washed as the dirty media passes downward along a wash path in the wash device in counter current flow to wash liquid which passes upward though the wash device. The washed media is then returned to the top of the filter bed zone. A zone of filtrated liquid phase is maintained above the filter bed, and a portion of said filtrated liquid phase is supplied to the wash device as the wash liquid. However, the system is mainly applied to physical filtration, and is not effective for aerobic biological treatment.

Various other wastewater treatment systems exist that perform backwashing of the filter media. Such wastewater treatment systems include aerated trickling filters having a rotating distributor and a backwash system. In the normal treatment mode, air is blown through a pressurized pipe at the bottom of the filter, which exhausts through the top of the media and the open vessel top. The sewage trickles through the filter material in counter flow with the ascending air. However, these systems use air bubbles exclusively to scour biofilm buildup from the filter material rather than backwashing to fluidize filter media.

Based on the foregoing there is a demonstrable need for a highly efficient cleaning means for progressively backwashing and fluidizing filter media in a wastewater treatment system that provides both physical filtration and aerated biological treatment. Such a needed cleaning means would progressively backwash and scour excessive biofilm off the media surfaces for a portion of the filter media at a time to minimize the required backwash flow. This system would provide a means for vertical media circulation within the filter thereby eliminating the stratification of media encountered with filters that fluidize the entire media bed at once. The system would also provide a pipe for containing the circulating media. Finally, this wastewater treatment system would provide a combination of an unsaturated filter with concurrent downward airflow and highly efficient backwashing utilizing eduction. The present invention overcomes prior art shortcomings by accomplishing these critical objectives.

### SUMMARY OF THE DISCLOSURE

To minimize the limitations found in the prior art, and to minimize other limitations that will be apparent upon the reading of the specification, the preferred embodiment of the present invention provides a means for progressively backwashing and fluidizing filter media in a highly efficient backwashing wastewater treatment system.

The present invention discloses a means that provides an improvement over the '678 patent, and enables the accomplishment of media fluidization and backwashing in a particularly efficient manner by use of progressive fluidization and scouring of a portion of the media at a time. The combination of generally unsaturated conditions and periodic backwashing of the media through progressive fluidization and scouring of the packed media enables a highly efficient backwashing in terms of backwash flow requirements.

The present invention provides a means for cleaning packed media in a backwashing wastewater treatment system for removing pollutants and pathogens from wastewater and other dirty water sources. The wastewater treatment system incorporating the means for cleaning comprises a filter inlet for receiving wastewater from a source outside the wastewater treatment system, a filter vessel for containing the wastewater, a filter media configured for treatment of the wastewater, a dosing means for dosing the filter media with the wastewater, and an underdrain fluidly connected to the filter vessel for discharging treated wastewater from the vessel.

In the preferred embodiment, an eductor consisting of a pressurized water jet periodically discharges near a pipe inlet of an upflow pipe. The water jet provides the motive force for drawing water and filter media from the lower portion of the filter vessel into the upflow pipe, extending from near the bottom of the filter vessel to slightly above the surface of the media, for progressively backwashing, fluidizing, and redistributing a portion of the media at a time. A pump periodically provides treated wastewater from a holding tank to the water jet of the eductor to induce the eduction flow. Additional treated wastewater is provided through the underdrain to supply the induced eduction flow and a net upflow through the entire filter media. The upflow pipe conveys the water and media to a discharge location slightly above the surface of the filter media wherein excess biofilm is scoured from the media particles by particle collisions in turbulent conditions. An overflow conduit collects the solids scoured from the filter media in the turbulent conditions in the upflow pipe to be discharged from the filter vessel through an exit port.

The wastewater treatment system provides both physical filtration and aerated biological treatment, and also incorporates upflow-isolated fluidization and backwashing of a portion of the filter media at a time. Backwashing removes excess solids caught in the filter media and controls the biofilm thickness and nature of the biofilm. The wastewater treatment system removes biochemical oxygen demand (BOD), suspended solids, and turbidity from wastewater to very low levels, similar to those found in conventional tertiary wastewater treatment plants. The combination of an unsaturated filter with concurrent downward airflow and high efficiency backwashing utilizing contained progressive upflow fluidization represents major step forward in wastewater treatment. The progressive backwashing also eliminates the stratification of media found in filters that backwash all the media at once, where finer media remain on top of the media bed and can restrict infiltration.

A first objective of the present invention is to provide a means for maintaining optimal biofilm, moisture, and oxygen conditions for wastewater treatment in a predominantly unsaturated filter with relatively fine packed media.

A second objective of the present invention is to progressively backwash and scour excessive biofilm off the media surfaces for a portion of the filter media at a time to minimize the required backwash flow.

A third objective of the present invention is to provide a means for vertical media circulation within the filter vessel to eliminate stratification of the media.

Another objective of the present invention is to provide an air vent located below the surface of an unsaturated backwashing filter to allow ready air movement down through and out of the filter.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a sectional side view of a schematic depiction of a backwashing wastewater treatment system in forward flow operation; and

FIG. 2 is a sectional side view of a schematic depiction of the backwashing wastewater treatment system in backwash mode of operation.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

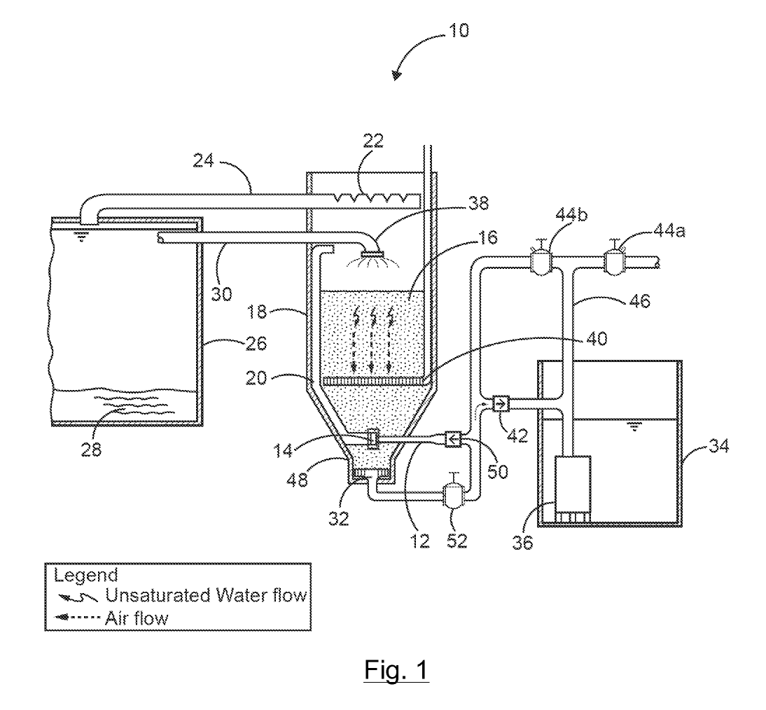

FIG. 1 is a sectional side view of a schematic depiction of the backwashing wastewater treatment system 10 in forward flow operation. The wastewater treatment system 10 incorporates a filter media cleaning means comprising an eductor consisting of a pressurized water jet 12 periodically discharging near a pipe inlet 14 that intermittently provides the motive force for progressively fluidizing a portion of a filter media 16 and drawing the water and filter media 16 from the lower portion of a filter vessel 18 into the pipe inlet 14. The cleaning means further comprises an upflow pipe 20 that conveys the water and the fluidized portion of the media 16 drawn into the pipe inlet 14 in turbulent conditions to a discharge location slightly above the surface of the filter media 16, and an overflow trough or conduit 22 that allows solids which have been separated from the filter media 16 in the turbulent conditions in the upflow pipe 20 to be discharged from the filter vessel 18 through an exit port 24.

It is noted that for purposes of this application the term “pipe” shall be defined as a conduit of any suitable shape, and not necessarily a round or cylindrical conduit. A septic tank 26 or other primary settling tank, upstream of the treatment system 10, receives raw wastewater and provides passive removal of settleable solids 28. Raw wastewater from the septic tank 26 is directed using a pump, gravity, or other means into a filter inlet 30 on the filter vessel 18. The filter vessel 18 comprises the filter media 16 configured for biological and physical treatment of wastewater, a dosing means for dosing the filter media 16 with the wastewater, and an underdrain 32 fluidly connected to the filter vessel 18 for discharging treated wastewater from the vessel 18 to a holding tank 34 comprising a pump 36, where treated wastewater is collected and periodically pumped back for progressive backwashing.

The dosing means may be a surface distribution device 38 that provides intermittent supply of wastewater evenly across the surface of the filter media 16. The application of wastewater to the filter media 16 provides brief intermittent episodes of saturation at the surface of the media 16 resulting in high distribution uniformity, while driving air down into the filter media 16 to provide oxygen for biological treatment. An air vent 40 in communication with and below the surface of the media 16 provides a conduit to exhaust downwardly flowing air to the outside of the media 16. The air vent 40 may comprise a slotted pipe or an open-bottom shaped container that allows air to more easily leave the pores of the media 16 in the filter. The surface of the media particles provides sites for attached microbial growth and biological treatment. The wastewater is treated as it flows downwards by gravity through pores in the filter media 16. The treated wastewater is collected in the underdrain 32 at the bottom of the filter vessel 18. The treated wastewater is then transferred to the holding tank 34. A check valve 42 is provided on the supply pipeline to the holding tank 34 to allow drainage flow of treated wastewater during normal forward-flow operation (i.e. not during backwashing).

The treated wastewater in the holding tank 34 is either discharged to the outside or pumped back into the filter vessel 18 for backwashing. Two control valves 44a and 44b are provided on a discharge pipeline 46 of the holding tank 34 to ensure that the treated wastewater pumped out of the tank 34 flows in the right direction. When the treated wastewater is discharged to the outside, the control valve 44a remains open and the control valve 44b remains closed. When the treated wastewater is pumped back to the filter vessel 18 for backwashing, the control valve 44a remains closed and the control valve 44b remains open.

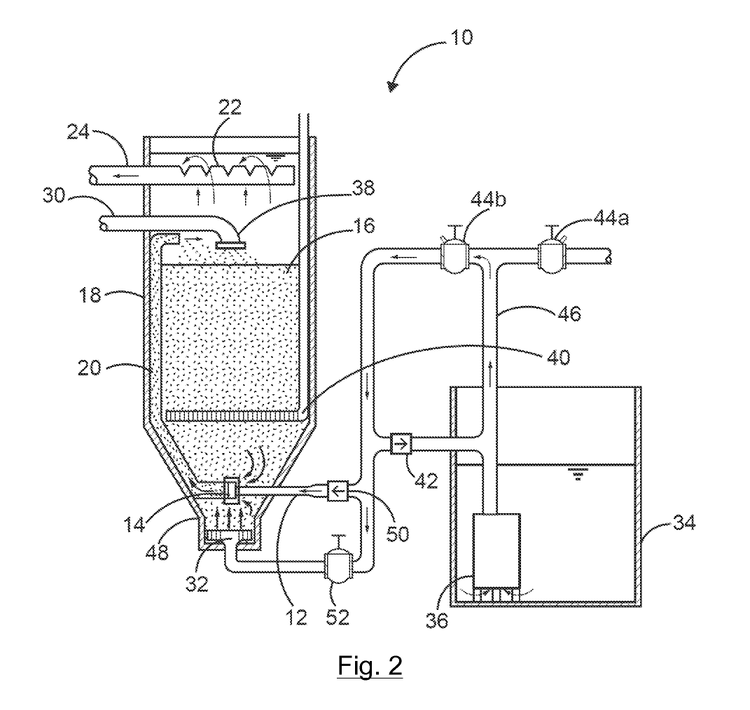

FIG. 2 is a sectional side view of a schematic depiction of the backwashing wastewater treatment system 10 in a backwash mode of operation. In this mode of operation a portion of the media 16 is progressively fluidized and backwashed. The pump 36 periodically provides treated wastewater from the holding tank 34 to the underdrain 32 and the water jet 12 of the eductor to progressively fluidize, clean, and redistribute the filter media 16. The water jet 12 at the lower portion of the filter vessel 18 acts as a flow eductor and induces a flow of treated wastewater and filter media 16 into the upflow pipe 20. Additional treated wastewater is provided through the underdrain 32 to supply the induced eduction flow and a net upflow through the entire filter media 16.

The filter vessel 18 includes a conical narrowing 48 at the bottom to encourage more uniform downward movement of filter media 16 in the main body of the filter vessel 18 during cleaning. The filter vessel 18 may further comprise an internal inverted cone or other media distribution aid for easy movement of media 16 during the progressive backwash process. The upflow of treated wastewater from the underdrain 32 provides fluidization of the filter media 16 at the bottom of the filter vessel 18. A valve 50 is provided on the supply pipeline to the pressurized water jet 12 to prevent significant backflow of media 16 into the jet supply pipeline. The valve 50 may be a check valve or, if located in an elevated position, a vacuum release valve. A control valve 52 is provided on the conveyance pipeline to the underdrain 32 to ensure the right direction of flow of treated wastewater during the forward flow operation and the backwash mode of operation.

In the preferred embodiment, eduction is utilized to provide the motive force to transport treated wastewater and media 16 into and through the upflow pipe 20 for discharge at a location slightly above the surface of the media 16. During the eduction, upflow, and redistribution of the filter media 16, the media particles are scoured through particle collisions in the turbulent conditions to remove excess biofilm. Backwashing not only removes excess solids caught in the filter media 16, but it also controls the biofilm thickness and nature of the biofilm. Backwashing keeps the biofilm lean and reduces mass transfer limitations from the wastewater to the microbes performing biodegradation of the pollutants. The backwash water with the scoured excess biofilm and other particulates leaves the filter vessel 18 through the overflow conduit 22 and exit port 24.

The present invention provides a means for cleaning packed media in backwashing wastewater treatment system 10 for removing pollutants and pathogens from wastewater and other dirty water sources. The means for cleaning comprises the filter inlet 30 for receiving wastewater from a source outside the wastewater treatment system 10, the filter vessel 18 for containing the wastewater, the filter media 16 configured for biological and physical treatment of the wastewater, the dosing means for dosing the filter media 16 with the wastewater, the underdrain 32 fluidly connected to the filter vessel 18 for discharging treated wastewater from the vessel 18, and the eductor consisting of the pressurized water jet 12 periodically discharging near the pipe inlet 14 of the upflow pipe 20. The water jet 12 provides the motive force for drawing water and filter media 16 from the lower portion of the filter vessel 18 into the upflow pipe 20, extending from near the bottom of the filter vessel 18 to above the surface of the media 16, for progressively backwashing, fluidizing, and redistributing a portion of the media 16 at a time.

A method of backwashing the wastewater treatment system 10 utilizing eduction includes the following steps. First, treated wastewater from the holding tank 34 is pumped to the underdrain 32 and the pressurized water jet 12 within the filter vessel 18 of the treatment system 10. A flow of treated wastewater and filter media 16 from the lower portion of the filter vessel 18 is induced into the upflow pipe 20 by the motive force provided by the water jet 12. The water and media 16 is then conveyed in the upflow pipe 20 to slightly above the surface of the filter media 16 wherein the media 16 is scoured in the upflow pipe 20 to remove excess biofilm and particulates through particle collisions in turbulent conditions. The solids that have been separated from the filter media 16 are then collected by the overflow conduit 22 and discharged through the exit port 24 to the septic tank 26 upstream of the wastewater treatment system 10.

The backwash water discharged into the septic tank 26 after the backwashing process enters the wastewater treatment system 10 again with raw wastewater for treatment. The wastewater treatment system 10 provides both physical filtration and aerated biological treatment, similar to non-backwashing wastewater filters, but also incorporates upflow isolated backwashing of a portion of the filter media 16, a technique previously only used in high saturated upflow filters.

The presently disclosed system is advantageous because it provides high levels of both wastewater treatment and physical filtration in a much smaller footprint than conventional unsaturated wastewater filters. The wastewater treatment system 10 removes biochemical oxygen demand (BOD), suspended solids, and turbidity from wastewater to very low levels, similar to those found in conventional tertiary wastewater treatment plants. Furthermore, the backwash mode of the wastewater treatment system 10 is particularly efficient in that a minimal amount of flow capacity is required for backwashing. Progressive backwashing enables the use of substantially lower backwash flows and correspondingly smaller backwash pump, pipe, and valves.

The backwashing redistributes the filter media 16 from the bottom to the top of the filter vessel 18, thereby eliminating media stratification often encountered with filters that fluidize the entire media bed at once, where finer media remain on top of the media bed and can restrict infiltration. The eduction means for backwashing and transporting the filter media 16 to the top of the filter vessel 18 is a simple device powered by externally supplied water pressure eliminating the need for internal moving parts. The turbulence and shearing forces with the eductor eliminate the need for a separate wash device to scour the media 16. With eduction, the upflow pipe 20 does not need to be vertical as it does with air-lift pumping of backwash water and media.

In an alternative embodiment of the present invention, an air-lift system could be utilized in place of the water jet 12 to progressively backwash the filter media 16. The water pressure for eduction may be supplied by other suitable means and devices known in the art other than the pump 36. The control valves 44a and 44b provided on the discharge pipeline 46 of the holding tank 34 may be changed to a single three-way valve for greater compactness. A second pump could be utilized instead of valves, but would be more costly.

Filter media 16 with a high specific surface area, that fluidizes and cleans easily during backwashing, and that has good water holding capacity are generally preferred. Materials such as sand, pumice, shaped plastic, or other relatively fine media can be used. Preferably, most filter components should be made of materials that resist corrosion or degradation in wet conditions, such as but not limited to plastic or stainless steel.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

I claim:

1. A filter media cleaning means for packed media treatment filters, the media cleaning means comprising:
an eductor consisting of a pressurized water jet periodically discharging near a pipe inlet that provides the motive force for progressively fluidizing a portion of the media and drawing the water and filter media from the lower portion of the filter into the pipe inlet;
an upflow pipe that conveys the water and the fluidized portion of the media drawn into the pipe inlet in turbulent conditions to a discharge location above the surface of the filter media; and
an overflow conduit that allows solids which have been separated from the filter media in the turbulent conditions in the upflow pipe to be discharged from the filter through an exit port.

2. The filter media cleaning means of claim 1 wherein the water jet is periodically supplied with treated wastewater from a holding tank that has received the treated wastewater from the filter during normal forward flow operation.

3. The filter media cleaning means of claim 1 wherein additional treated wastewater is provided through an underdrain in the filter to supply the induced eduction flow and a net upflow through the entire filter media.

4. The filter media cleaning means of claim 1 wherein the filter vessel includes a conical narrowing at the bottom to encourage more uniform downward movement of filter media in the main body of the filter during cleaning.

5. The filter media cleaning means and filter of claim 3 or 4 whereby the upflow of treated wastewater from the underdrain provides fluidization of filter media at the bottom of the filter.

6. The filter media cleaning means and narrowing conical filter vessel of claim 4 further comprising an internal inverted cone or other media distribution aid.

7. The filter media cleaning means of claim 1 wherein backwashing redistributes the media from the bottom to the top of the filter thereby eliminating media stratification.

8. The filter media cleaning means of claim 1 wherein a valve is provided on the supply pipeline to the pressurized water jet to prevent significant backflow of media into the jet supply pipeline.

9. The filter media cleaning means of claim 8 wherein the valve is a check valve.

10. The filter media cleaning means of claim 8 wherein the valve is a vacuum release valve.

11. A means for cleaning packed media in a backwashing wastewater treatment system for removing pollutants and pathogens from wastewater and other dirty water sources, the means for cleaning comprising:
a filter inlet for receiving wastewater from a source outside the wastewater treatment system;
a filter vessel for containing the wastewater, the vessel comprising a substantially unsaturated packed filter media configured for biological and physical treatment of the wastewater and wherein the wastewater is treated as it flows by gravity through pores in the filter media;
a dosing means for dosing the filter media with the wastewater;
an underdrain fluidly connected to the vessel for discharging treated wastewater from the vessel;
whereby the cleaning means cleans the filter media through intermittent progressive backwashing, fluidization, and redistribution of a portion of the media in an upflow pipe extending from near the bottom of the filter to above the surface of the media.

12. The means for cleaning of claim 11 wherein eduction is utilized to provide the motive force to transport water and media into and through the upflow pipe for discharge above the surface of the media.

13. The means for cleaning of claim 11 wherein treated wastewater collected in a holding tank is periodically pumped through the water jet to induce the eduction flow.

14. The means for cleaning of claim 11 further comprising an air vent in communication with and below the surface of the media, thereby providing a conduit to exhaust downwardly flowing air to the outside of the media.

15. The means for cleaning of claim 11 wherein the wastewater treatment system provides physical filtration and aerated biological treatment of wastewater while incorporating upflow isolated backwashing of a portion of the filter media.

16. A method of backwashing a wastewater treatment system utilizing eduction, the method comprising the steps of:
a) pumping treated wastewater from a holding tank to an underdrain and a pressurized water jet within a filter vessel of the treatment system;
b) inducing a flow of treated wastewater and filter media from the lower portion of the filter vessel into an upflow pipe by the motive force provided by the water jet;
c) conveying the water and media in the upflow pipe to discharge location above the surface of the filter media wherein the filter media being scoured in the upflow pipe to remove excess biofilm and particulates through particle collisions in turbulent conditions; and
d) collecting the solids that have been separated from the filter media by an overflow conduit and discharging through an exit port.
